(19) United States
(12) Patent Application Publication
(10) Pub. No.: US 2025/0039187 A1
(43) Pub. Date: Jan. 30, 2025

(54) METHOD, APPARATUS, AND NON-TRANSITORY MACHINE-READABLE STOR-AGE MEDIUM FOR ACCESS CONTROL, AND METHOD FOR GENERATING A TRUST DECISION MODEL

(71) Applicant: Intel Corporation, Santa Clara, CA (US)

(72) Inventors: Dan HOROVITZ, Rishon Lezion (IL); Ilil BLUM SHEM-TOV, Kiryat Tivon (IL); Yoni KAHANA, Kfar Hess (IL); Yaron KLEIN, Rosh Haayin (IL); Assaf GUREVITZ, Ramat Hasharon (IL)

(21) Appl. No.: 18/818,669

(22) Filed: Aug. 29, 2024

(51) Int. Cl. H04L 9/40; H04B 7/06; H04L 41/16

(52) U.S. Cl. CPC H04L 63/107; H04B 7/0626; H04L 41/16

(57) ABSTRACT

Provided is a method for location-based access control in a wireless network. The location of a user device is determined based on a Channel State Information (CSI) matrix of the user device as trusted or untrusted. Based on the trust state, which is trusted or untrusted, of the user device, access control is performed. In some examples, in order to determine the trust state of the user device, the CSI matrix of the user device needs to be input into a machine learning model or be compared with CSI matrices corresponding to multiple trusted locations using a similarity measure. Because the access control is based on the location of the user device, the conveniency and accuracy of the access control could be better than that made by some other security measures, such as password-based mechanisms.

### BACKGROUND

In today's digital era, the increasing reliance on wireless networks and devices for personal, professional, and commercial purposes has amplified the need for robust and reliable security mechanisms. Traditional access control systems often relying on passwords or credentials may be cumbersome and vulnerable to hacking, theft, or misuse in some situations.

### BRIEF DESCRIPTION OF THE FIGURES

Some examples of apparatuses and/or methods will be described in the following by way of example only, and with reference to the accompanying figures, in which

FIG. 1 shows a schematic figure of an example of a system 100 for location-based access control;

FIG. 2 shows a flow chart of an example of a method 200 for location-based access control;

FIG. 3 shows a flow chat of an example of a method 300 of generating a trust decision model;

FIG. 4 shows a diagram of an example of a method 400 of generating a trust decision model 430 based on machine learning;

FIG. 5 shows a flow chart of an example of a method 500 of generating a trust decision model based on machine learning;

FIG. 6 shows a diagram of an example of a system comprising a trusted decision model 600;

FIG. 7 shows a block diagram of an example of an apparatus of access control; and

FIG. 8 shows a block diagram of an example of the apparatus 800.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

Some examples provide the following access control measures.

Password-Based Authentication: it is a common method where users are required to enter a unique password that matches the stored password in the system.

Physical Tokens or ID Cards: these are tangible items that a user possesses to gain access, such as a smart card, key fob, or an employee ID card.

Biometrics: it involves verifying a user's identity based on unique physical or behavioral characteristics, such as fingerprints, facial recognition, retinal scans, or voice recognition.

Personal Identification Numbers (PINs): it requires the user to enter a numeric password, often used in combination with a physical token like a debit card.

IP-based Geolocation: it performs access control based on the geographic location of the IP address of an access request or a user device. However, this can be bypassed using VPNs or Proxy servers and considered as being not a secure method since it can be bypassed easily in some scenarios.

Security Questions: These are personal questions that only the specific user should know the answer to. This method is often used as a secondary form of authentication or for password recovery.

Multi-Factor Authentication (MFA): This involves using two or more of the above methods in conjunction to verify a user's identity, for instance, requiring both a password and a biometric scan to grant access.

Virtual Private Network (VPN): VPNs allow remote users to connect securely to a private network, but they do not typically offer location-based access control or hardware fingerprinting.

While these above measures provide some level of control and security, they each may have limitations. For example, they may lack trusted location-based access control. Moreover, they might require a lot of user intervention that is not friendly to users.

Some examples of the present disclosure provide a method for location-based access control in a wireless network. The location of a user device is determined based on a Channel State Information (CSI) matrix of the user device as trusted or untrusted. Based on the trust state, which is trusted or untrusted, of the user device, access control is performed. In some examples, in order to determine the trust state of the user device, the CSI matrix of the user device may be input into a machine learning model or be compared with CSI matrices corresponding to multiple trusted locations using a similarity measure. Because the access control is, directly or indirectly, based on the location, exemplarily via the CSI matrix, of the user device, the conveniency and accuracy of the access control may be better than some other security measures, such as password-based mechanisms. Therefore, the other security measures may be reduced in some scenarios and the method for location-based access control may serve as a complement measure to the other security measures in some other scenarios.

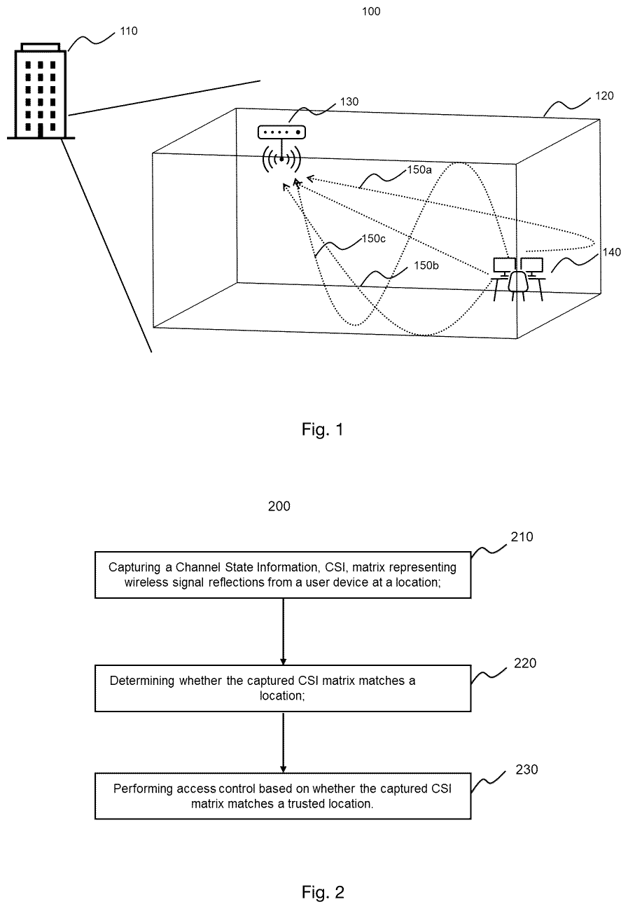

FIG. 1 shows a schematic figure of an example of a system 100 for location-based access control. The system 100 comprises a building 110 comprising a room 120, where an access point 130 and at least one user device 140 are located. In order to perform access control for the user device 140, the access point 130 captures a Channel State Information (CSI) matrix. As will be understood by the skilled person having benefit from the present disclosure, the CSI matrix is dependent on the wireless communication channel between access point 130 and user device 140. The wireless channel and thus the CSI matrix are therefore dependent on the location of the user device 140, such as room 120 or one or more positions within room 120. Then a controller, which could be the access point 130 or another external device not shown in FIG. 1, determines whether the captured CSI matrix matches a trusted location. Based on whether the captured CSI matrix matches a trusted location, access control is performed for the user device 140.

In some examples, a CSI matrix may provide a detailed representation of the wireless channel conditions between a transmitter and a receiver. This matrix may capture both the amplitude and phase shifts that occur across multiple subcarriers in an OFDM (Orthogonal Frequency Division Multiplexing) system, allowing for a granular analysis of the channel's characteristics. Each element of the CSI matrix is a complex number that reflects the channel's response between a specific transmit and receive antenna pair for a particular subcarrier, making it a crucial tool for optimizing wireless communication techniques such as beamforming, MIMO (Multiple-Input Multiple-Output), and adaptive modulation. In some other examples, a simplified CSI matrix may include the amplitude without the phase shift.

In some examples, the access point 130 is a Wi-Fi access point, and in some other examples, the access point is a base station according to a standard of 3^{rd} Generation Partnership Project (3GPP), or other types of access point for a wireless user device. Consequently, the wireless signals, including both directed transmitted signals and signal reflections, may be associated with Wi-Fi signals, or 3rd Generation Partnership Project, 3GPP, wireless signals. In some examples, the access point may support both the Wi-Fi signals and 3GPP signals, therefore, the wireless signals may be associated with both Wi-Fi signals and 3GPP signals. In some examples where the controller is not the access point 130, the controller may be deployed in a remote server. In some examples, the user device 140 could be a laptop, a smartphone, a tablet, a personal computer, a smart watch, or another type of smart device. In some examples, a CSI matrix of the user device 140 represents a wireless channel from the user device 140 to the access point 130. Thus, the CSI matrix of the user device 140 may be unique to the location of the user device 140. When the user device 140 moves from one location to another location, the values of the CSI matrix of the user device 140 will change correspondingly. As a CSI matrix is unique to the location of the user device 140, a plurality of different CSI matrices may respectively correspond to the plurality of different locations. Therefore, the CSI matrix may be used as a unique location-based identifier for user device 140.

FIG. 2 shows a flow chart of an example of a method 200 for location-based access control according to an example of the present disclosure.

The method 200 for location-based access control comprises capturing 210 a CSI matrix based on a location of a user device; determining 220 whether the captured CSI matrix matches a trusted location; and performing 230 access control based on whether the captured CSI matrix matches a trusted location. According to the method 200, access control for a wireless user device may be performed based on location, so that the accuracy of access control may be improved and/or the complexity of the access control may be reduced.

In some examples, capturing 210 the CSI matrix may be performed by the access point 130 or by a controller. In a more specific example, the wireless signals are Wi-Fi signals, and capturing 210 may be performed by a Wi-Fi firmware installed in the access point 130. When capturing 210 is performed by the controller, capturing 210 by the controller refers to that the controller receives the CSI matrix captured by the access point 130. In some examples, the captured CSI matrix of Wi-Fi signals is considered as a Wi-Fi signature or an important component of a Wi-Fi signature, which is unique to the location of user device 140.

In some examples, determining 220 whether the captured CSI matrix matches a trusted location is based on a machine learning method. For example, the determination 220 comprises inputting the captured CSI matrix or features thereof into a machine learning model trained to predict a likelihood that the captured CSI matrix corresponds to one of trusted locations. The machine learning model may determine whether the captured CSI matrix matches a trusted location based on the input. In order to implement the capability of the determination or predication, an artificial neural network (ANN) or a support vector machine (SVM), which are trained to determine whether the CSI matrix corresponds to a trusted location, may be included in the machine learning model in some examples.

In some examples, in order to obtain the above machine learning model, training the machine learning model is needed. The training may be based on ground truth pairs of CSI matrices and corresponding trusted or untrusted locations. Both CSI matrices of trusted locations and CSI matrices of untrusted locations are helpful to the training the machine learning model.

Some examples provide an alternative training of the machine learning model. In one example, the training may comprise classifying the location of the user device as a trusted location if the user may successfully log into the wireless network based on a captured CSI matrix of the user device. Then, the machine learning model is trained by using at least one CSI matrix based on the trusted location as input of the training. The CSI matrix of the user device may refer to the CSI matrix based on a location of the user device. In another example, a trusted user is asked by the machine learning model or a training controller to label the location of the user device as a trusted or untrusted location, or to verify a prediction made by the machine learning model. Based on the feedback of the trusted user, the location of the user device is labeled as a trusted location, or a prediction made by the machine learning model is verified by the trusted user as true or false. When the feedback that whether the location of the user is a trusted location or whether the prediction made by the machine learning model is true is used as input, the machine learning model is incrementally trained. In some examples, the training may be implemented by a device or a system comprising a plurality of devices configured to train the model. The trained machine learning model may determine or make decisions on whether a user device is in a trusted location based on the captured CSI matrix of the user device. Therefore, the trained machine learning model may be called a trust decision model in some examples. In some examples, a CSI matrix of a user device refers to

CSI matrices may be sensitive to any change of a wireless channel, e.g. a change caused by a walking person, and/or a change caused by a position change of a user device. Therefore, the trust decision model in some examples is able to address a challenge caused by change of the signal channel and is still able to identify that a CSI matrix is of a trusted location when some changes of signal channel exist at the trusted location. In other words, some changes of a signal channel at a trusted location should not prevent the trust decision model in some examples from correctly recognizing a CSI matrix of the location.

In some examples, when determining 220 whether a captured CSI matrix matches a trusted location, the process may involve capturing the CSI matrix from a user device and analyzing statistical properties of the captured CSI matrix, such as mean, variance, and covariance. These properties may provide detailed insights into the wireless channel characteristics of the wireless channel associated with the CSI matrix, including amplitude and phase shifts for various subcarriers and antennas. The captured CSI matrix's statistical properties may be then compared with those of CSI matrices from known trusted locations. Similarity measures like Euclidean distance, Mahalanobis distance, and correlation coefficient may be employed to assess the degree of match. Euclidean distance may calculate the straight-line distance in a multi-dimensional space, while Mahalanobis distance may consider correlations between variables, and the correlation coefficient may measure the linear relationship between the properties.

In some examples, the comparison may use any combination of the mean, variance, and covariance to get an accurate match. For example, in an office environment, the system may capture and analyze the mean, variance, and covariance of the CSI matrix and compare these values with pre-stored statistical properties from trusted office locations. If the similarity measure, such as Mahalanobis distance, indicates a close match, the device or system may conclude that the user device, which may be a smartphone, laptop, and/or tablet, is in a trusted location. Otherwise, it may trigger a security alert or initiate further verification or authentication steps.

In some examples, the method 200 need not replace traditional authentication methods. For some users or according to some policies, some traditional authentication methods may be waived when a user device is identified as being in a trusted location. In some examples, method 200 may be used to complement, not replace, other security measures. While method 200 is a unique and highly secure method of access control, it may also acknowledge the utility and familiarity of password-based security measures in some scenarios. As such, scalability of choosing a preferred method of access control depending on the situation is provided.

In some examples, when users are at home or in a designated trusted location, such as an IT organization in case of corporate device, the need for MFA or additional security measures may be dropped. In another example, users may opt to use an access point (AP) signature for a seamless and convenient access experience, where the need for entering passwords is eliminated. The convenience can be particularly beneficial for those who struggle to remember multiple complex passwords. However, when a user is outside these locations or in a potentially insecure environment, password-based security measures may be required. This dual system may ensure maximum flexibility and security for users, catering to various situations and needs.

Performing 230 access control may include granting access to the wireless network if the captured CSI matrix matches a trusted location and denying access if the captured CSI matrix does not match a trusted location. By granting access to the wireless network, the access control is both safe and concise. In some other examples, some measures for access control may be waived if the captured CSI matrix matches a trusted location. This means that some other measures for access control may still need to be performed to further improve the accuracy of the access control and improve the safety of the data to be accessed.

In some examples, the wireless signals are associated with Wi-Fi signals, and/or 3rd Generation Partnership Project, 3GPP, wireless signals. For example, the Wi-Fi signals may be Wi-Fi 4 signals, Wi-Fi 6 signals and/or Wi-Fi 7 signals, the 3GPP signals may be 5G signals and/or 6G signals.

In some examples, the method 200, which comprises enhanced security measures, may be suitable for data protection, especially suitable for protecting sensitive and critical data, such as health files, top-secret documents, defense files, crypto wallets, and password vaults.

In some examples, the method 200 may be provided to enable or disable system features based on the trusted locations, such as disabling or enabling system cameras based on the trust state, which is trusted or untrusted, of a specific location.

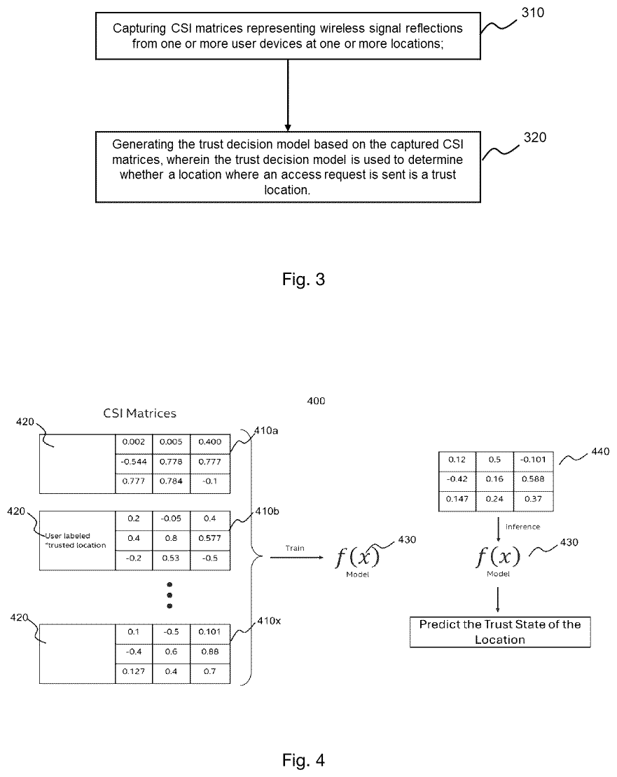

FIG. 3 shows a flow chat of an example of a method 300 of generating a trust decision model. The method 300 of generating a trust decision model comprises capturing 310 CSI matrices based on one or more locations of one or more user devices. Method 300 further comprises generating 320 the trust decision model based on the captured CSI matrices. The trust decision model is used to determine whether a location where an access request is sent is a trusted location. In some examples, the trust decision model generated by method 300 is the trust decision model provided in some examples corresponding to FIG. 2.

In some examples, the trust decision model is generated based on a machine learning method. In some other examples, the trusted decision model is generated based on a statistical method. In yet some other examples, the trusted decision model is generated based on both the machine learning method and the statistical method.

In some examples associated with the machine learning method, a machine learning model (trust decision model) may be trained based on ground truth pairs of CSI matrices and trusted or untrusted locations to generate the trust decision model.

FIG. 4 shows a diagram of an example of a method 400 of generating a trust decision model 430 based on a machine learning method. As shown in FIG. 4, a plurality of CSI matrices 410 may be used as input to train a machine learning module to generate the trust decision model 430. As an exemplary figure, FIG. 4 shows a plurality of 3×3 CSI matrices, which could be associated with a Multiple-In, Multiple-Out (MIMO) system with 3 transmitting antennas and 3 receiving antennas. Each of the 9 elements in a 3×3 CSI matrix shown in FIG. 4 may represent a complex channel coefficient of a channel from a transmitting antenna to a receiving antenna. The complex channel coefficient may comprise amplitude and phase of the signal for each subcarrier in an OFDM (Orthogonal Frequency-Division Multiplexing) system, for example. In some other examples, the CSI matrices 410 could be M×N matrices, where M is not equal to N.

In some examples, each of the plurality of CSI matrices 410 may be labeled by a trusted user with a trust state 420. The trust state 420 may indicate that the respective location associated with the respective CSI matrix 410 is a trusted or untrusted location. As explained before, a CSI matrix 410 may represent a wireless channel from a user device at a location to an access point. Thus, the location of the user device is the location associated with the CSI matrix. In some examples, the wireless signals received at the access point may include line-of-sight signal components and/or reflected signal components (echoes), either constructively or destructively interfering with each other. The CSI matrix 410 and the trust state 420, which is trusted or untrusted, of the location associated with the CSI matrix may be considered as a ground truth pair. When each of the plurality of CSI matrices is labeled by a user as being of a trusted or untrusted location, the plurality of CSI matrices represents the plurality of ground truth pairs of CSI matrices 410 and trust states 420.

As shown in FIG. 4, the plurality of ground truth pairs of CSI matrices 410 and trust states 420 may be used as input to train the machine learning model, which could be an artificial neural network (ANN) or a support vector machine (SVM) to generate the trust decision model 430. After the trust decision model 430 is generated by the above training, the trust decision model 430, now being capable of making inference, may predict whether the captured CSI matrix 440 is associated with a trusted location or an untrusted location.

In some examples, all CSI matrices 410 used as input to generate the trust decision model may be labeled as being of trusted locations. The generated trust decision model in these examples may be good at determining CSI matrices of trusted locations. In some other examples, all CSI matrices 410 used as input to generate the trust decision model may labeled as being of untrusted locations. The generated trust decision model in these other examples may be good at determining CSI matrices of untrusted locations. In yet some other examples, both CSI matrices labeled as being of trusted locations and CSI matrices labeled as being of untrusted locations may be used as input to generate the trust decision model, so that the generated trust decision model may be more balanced in its capability of determining whether a CSI matrix is of a trust location or an untrust location.

In some examples, one or more threshold bars may be configured for the training. The configuration of the one or more threshold bars provides high possibility of correctly identify trusted locations and low possibilities of making “false positive” notifications. In some examples, threshold bars may be configured per need. For example, a first threshold bar can be configured with a first value for a first need of the trust decision model and a second threshold bar can be configured with a second value for a second need of the trust decision model. The first need and the second need are different types of needs. For example, the first need and the second need may be two of extremely high accuracy of a positive prediction, very high accuracy of the positive prediction, high accuracy of a positive prediction, high accuracy of a negative prediction, very high accuracy of a negative prediction, and extremely high accuracy of a negative prediction. The positive prediction may refer to predicting that a user device is in a trusted location, and the negative prediction may refer to predicting that a user device is in an untrusted location. In some examples, the threshold bars may be signal strength, CSI matrix quality, temporal stability, spatial resolution, frequency, bandwidth, and/or calibration. The signal strength may be used to set the minimum acceptable signal strength to consider a CSI matrix reliable. The CSI matrix quality may include variance, mean and other statistical measures to filter out noise. The temporal stability may represent consistency of CSI measurements over time. The spatial resolution may represent the spatial resolution of the CSI data, which may involve the granularity of phase and amplitude information. The frequency and bandwidth, independently or in combination, may be used to set up a wireless communication. The calibration may be used to ensure consistency across different devices and environments. In an example, if one or more threshold bars are configured appropriately, the determination made by the trust decision model on whether a user or a user device of the user is in a trusted location is highly close to the fact or real situation.

Based on the determination made by the trust decision model, an application in some examples may make some further determinations. For example, the further determinations may be on whether it will reduce other security controls, and/or whether the application and the trust decision model run on a same hardware device or on different hardware devices. If it is determined that other security controls should be reduced, it may further determine on how, what and/or when to reduce. In an example, the reducing other security controls includes the waive on Multi-Factor Authentication (MFA).

By ensuring that access is only granted in specific, approved locations, the risk of unauthorized access or hacking would be significantly reduced. This provides an extra layer of security for users, which makes their digital assets and sensitive information better protected.

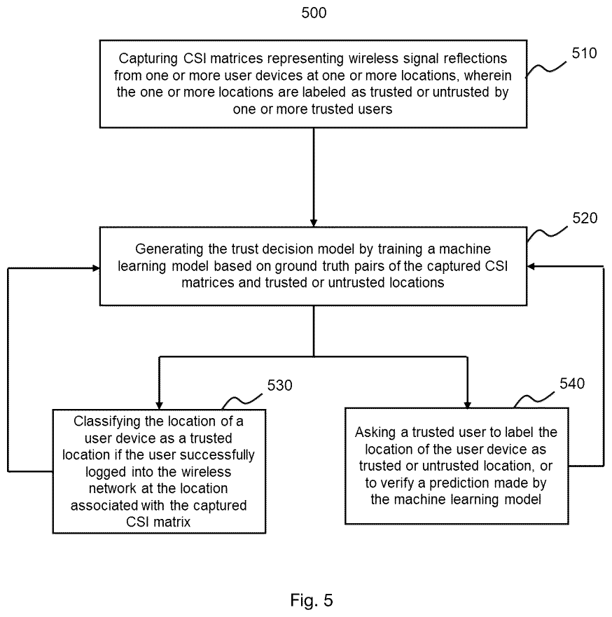

FIG. 5 shows a flow chart of an example of a method 500 of generating a trust decision model based on a machine learning method. The method 500 of generating a trust decision model comprises capturing 510 CSI matrices based on one or more locations of one or more user devices, wherein the one or more locations are labeled as trusted or untrusted by one or more trusted users. In some examples, capturing 510 may be performed by an access point, such as a Wi-Fi router or a 3GPP base station. In some other examples, the capturing 510 may include receiving, by a controller, the CSI matrices captured by one or more access points. The controller may be coupled with the one or more access points via wired or wireless connections. In some examples, the captured CSI matrices are the CSI matrices 410 associated with FIG. 4.

In some examples, the method 500 further comprises generating 520 the trust decision model by training a machine learning model based on ground truth pairs of the captured CSI matrices and trust states associated with the CSI matrices. A ground truth pair may comprise a CSI matrix and a trust state associated with the CSI matrix, where the trust state may be trusted or untrusted, and the trust state associated with the CSI matrix may represent whether the CSI matrix is associated with a trusted location or an untrusted location. For example, a CSI matrix 410 in FIG. 4 may represent a ground truth pair because it both comprises a 3×3 CSI matrix and comprises a trust state 420. Based on the ground truth pairs, the trust decision model, such as model 430 in FIG. 4, may be generated.

In some examples, after the trust decision model is generated, the trust decision model may perform access control for a user device based on the captured CSI matrix associated with the user device. The access control may be based on whether the trust decision model predicts that the user device is at a trust location or an untrusted location. The CSI matrix associated with the user device refers to a CSI matrix dependent on the location of a user device. If the user of the user device successfully logged into the wireless network at the location associated with the captured CSI matrix, method 500 further comprises classifying 530 the location of the user device as a trusted location. Based on the classification, a new ground truth pair comprising the captured CSI matrix and the trust state, which indicates a trusted location, is generated. Then, the new ground truth pair is used as input to incrementally train the machine learning model, so that the trust decision model will be consequently improved.

In some examples, the method 500 further comprises asking 540 a trusted user to label the location of the user device as trusted or untrusted location, or to verify a prediction made by the machine learning model. In some examples, the trusted user could be a user who is predicted by the trust decision model as being at a trusted location, and/or be a user who gets trusted based on one or more traditional security measures. Based on the action of labeling by the trusted user, a trust state associated with the location is generated. Consequently, the CSI matrices of this location, which is identified as trusted or untrusted, may be used to further training on the machine learning model. The further training may improve the trust decision model. In another example, where the trusted user is asked to verify a prediction made by the machine learning model, the verification made by the trusted user may be used to train the machine learning model. If, for example, the verification is that the prediction is correct, the machine learning model may be trained to make the same prediction for same or similar further situations. If the verification is that the prediction is wrong, the machine learning model may be trained to make a converse prediction for same or similar further situations. Based on operation 540, the accuracy of the trust decision model may be further improved. As operation 530 and operation 540 are not mutually exclusive to each other in many scenarios, the trust decision model may be improved by operation 530 and/or operation 540.

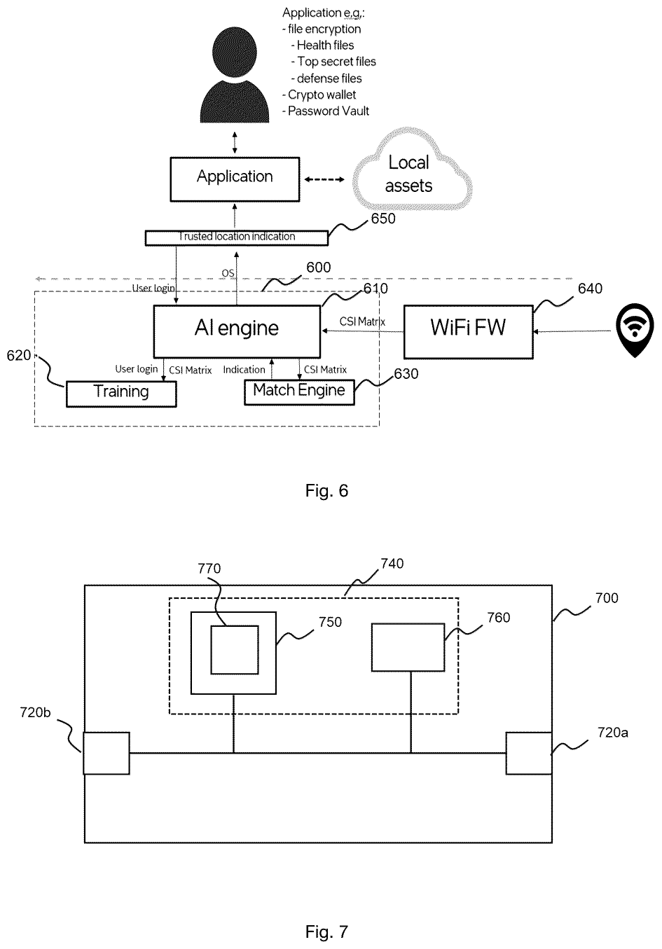

FIG. 6 shows a diagram of an example of a system comprising a trusted decision model 600 generated based on Artificial Intelligence (AI) and Wi-Fi CSI matrices. The trusted decision model 600 may comprise an AI engine 610, a training module 620 and a match engine 630.

In some examples, the AI engine 610 may receive the Wi-Fi CSI matrix captured by the Wi-Fi firmware 640 and may receive user login information from the trusted location indication module 650. In some examples, it may send the CSI matrix to both the training module 620 and the match engine 630 and send user login information to the training module 620. Furthermore, the AI engine 610 in some examples may process the indication received from the match engine 630 and send an output signal (OS) to the trusted location indication module 650. The trusted location indication module 650 may forward the OS to the Application 660 that manages connections with the user and local assets.

In some examples, the training module 620 may use the CSI matrix received from the AI engine 610 to train the AI model based on machine learning. The training involves learning patterns in the CSI data that correlate with user behavior, locations, and/or other factors. The training module 620 may continuously update the model with new data, improving its accuracy over time. Furthermore, the training module 620 may use user login information from the AI engine 610 to enhance the AI model's understanding of trusted locations and/or user behaviors. Besides that, the training module 620 in some examples may process and store CSI matrices and user login data for future training iterations.

In some examples, the match engine 630 may analyze the CSI matrix received from the AI engine 610 to determine if it matches the patterns of a trusted location and/or authorized user behavior. It may use the trained model to evaluate the CSI data against known patterns. Furthermore, the match engine 630 may send an indication back to the AI engine, indicating whether the CSI data matches a trusted profile or not.

In some examples, the trusted location indication Module 650 may receive the user login and CSI matrix analysis results from the AI engine and determine if the user is logging in from a trusted location based on the received data and the indication from the Match Engine. Furthermore, it may forward the OS received from the AI engine 610 to the Application 660.

In some examples, the application 660 may manage connections with both the user and local assets, controls access to sensitive data such as file encryption, crypto wallets, and password vaults based on the OS and indications received, where the file encryption may include heath files, top secret files and/or defense files. The application 660 may ensure that only users logging in from trusted locations or authorized behaviors can access sensitive data and implement necessary security measures based on the information received from the trusted location indication module 650.

In some examples, this trust decision model 600 may dynamically learn and adapt to new data while providing secure and efficient access control based on the analysis of Wi-Fi CSI data and/or user behavior.

In some examples, a plurality of or all the operations associated with access control and/or generating and using the trust decision model, such as operations associated with FIGS. 1, 2, 3, 4, 5, and/or 6 may be performed by a controller, which may be the access point itself or another device separate from the access point.

FIG. 7 shows a block diagram of an example of the apparatus 700. In some times, the apparatus 700 may include interfaces 720, such as 720a and 720b, and processing circuitry 740. The apparatus 700 may be configured to implement, based on the cooperation between one or more tangible computer-readable (“machine-readable”) non-transitory storage media 750 and one or more processors 760 of the processing circuitry 740, one or more examples, operations and/or functionalities described with reference to the FIGS. 1, 2, 3, 4, 5, and/or 6, and/or one or more operations described herein, which are associated with access control based on locations. The apparatus 700 performs the above implementations when the computer-executable instructions, e.g., implemented by the logic or computer program 770, are executed by the one or more processors 760. In some examples, the interfaces 720 are interface means 720 and the processing circuitry 740 is processing means 740. In some examples, the apparatus 700 is included in a computer system 700A which may include other apparatuses.

In some examples, the interfaces 720 is configured to capture a CSI matrix based on a location of a user device and the processing circuitry 740 is configured to determine whether the captured CSI matrix matches a trusted location and perform access control based on whether the captured CSI matrix matches a trusted location. In some examples, in order to determine whether the captured CSI matrix corresponds to one of trusted locations, the processing circuitry is configured to input the captured CSI matrix or features thereof into a machine learning model, where the machine learning model is trained to predict a likelihood that the captured CSI matrix corresponds to one of trusted locations. The machine learning model may be trained by the apparatus 700 or another apparatus. In an example where the machine learning model is trained by the apparatus 700, the processing circuitry 740 is configured to train the machine learning model based on ground truth pairs of CSI matrices and trusted or untrusted locations.

In some examples, in order to provide input or verification for the training, the processing circuitry 740 is configured to classify the location of the user device as a trusted location if the user successfully logged into the wireless network at the location associated with the captured CSI matrix. Another way of providing input or verification may be performed by the processing circuitry 740 may include asking a user to label the location of the user device as trusted or untrusted location, or to verify a prediction made by the machine learning model. The other way may further include using the user feedback to incrementally train the machine learning model. The above input or verification may be used to both initial training to machine learning model and incremental training after the machine learning model has been trained.

In some examples, the interfaces 720 may include one or more wireless interfaces including antennas, such as MIMO antennas, and/or wired interfaces, such as USB serial interfaces and/or RJ45 interfaces. The wireless interfaces with MIMO antennas may be used as a receiver to capture a CSI matrix based on the location of a user device. The wired interfaces may be used as a receiver to capture the CSI matrix by receiving the CSI matrix from another device. The wireless interfaces are configured to transmit and/or receive Wi-Fi signals, 3GPP signals and/or other wireless signals.

In some examples, the one or more processors 760 may be General Purpose CPUs, Mobile Processors, Server and Data Center Processors, Embedded Processors, Graphics Processing Units (GPUs), Specialized Processors, Microcontrollers, Field-Programmable Gate Arrays (FPGAs), Digital Signal Processors (DSPs), application-specific integrated circuits (ASICs), integrated circuits (ICs) and/or other circuitries having the capability of performing the operations of the controller in each and every example of this disclosure.

In some examples, the phrase “computer-readable non-transitory storage media” may be directed to include all machine and/or computer readable media, with the sole exception being a transitory propagating signal.

In some examples, the storage media 750 may include one or more types of computer-readable storage media capable of storing data, including volatile memory, non-volatile memory, removable or non-removable memory, erasable or non-erasable memory, writeable or re-writeable memory, and the like. For example, storage media 750 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some examples, the logic or computer program 770 may include instructions, data, and/or code, which, if executed by a machine, such as implemented by one or more processors in an apparatus, may cause the machine to perform a method, process, and/or operations as described herein, such as the examples, operations and/or functionalities comprises the examples, operations and/or functional of the access point associated with FIGS. 1, 2, 3, 4, 5, and/or 6, and/or the examples, operations and/or functional of the controller associated with FIGS. 1, 2, 3, 4, 5, and/or 6. The machine may include, for example, any suitable processing platform, computing platform, computing device, processing device, computing system, processing system, computer, processor, or the like, and may be implemented using any suitable combination of hardware, software, firmware, and the like.

In some examples, each of components 720, 740, 750, 760 and 770 in the apparatus 700 is implemented by a corresponding means capable of implementing the functions of the above components. In some examples, storage media 750 is not included in the apparatus 700 because processors 760 may read logic or computer program 770 from a storage media out of the apparatus 700.

In some examples, the logic or computer program 770 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner, or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

In some examples, interfaces 720, storage media 750 and processors 760 communicate with each other via bus and in some other examples, some such entities have direct communicative connections with each other.

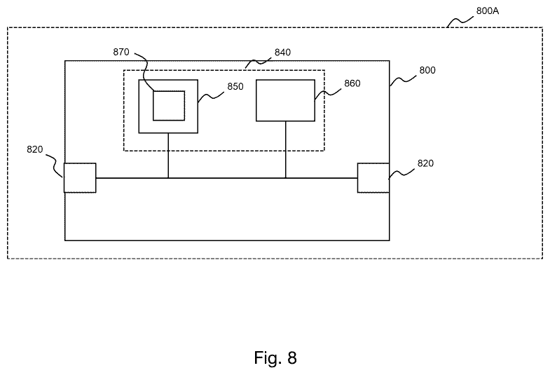

FIG. 8 shows a block diagram of an example of the apparatus 800. The apparatus 800 may include interfaces 820, such as 820a and 820b, and processing circuitry 840. The apparatus 800 is configured to implement, based on the cooperation between one or more tangible computer-readable (“machine-readable”) non-transitory storage media 850 and one or more processors 860 of the processing circuitry 840, one or more examples, operations and/or functionalities described with reference to the FIGS. 1, 2, 3, 4, 5, and/or 6, and/or one or more operations described herein, which are associated with generating and using the trust decision model based on machine learning and/or statistical methods. The apparatus 800 performs the above implementations when the computer-executable instructions, e.g., implemented by the logic or computer program 870, are executed by the one or more processors 860. In some examples, the interfaces 820 are interface means 820 and the processing circuitry 840 is processing means 840. In some examples, the apparatus 800 is included in a computer system 800A which may include other apparatuses.

In some examples, the interfaces 820 is configured to capture CSI matrices associated with one or more user devices at one or more locations and the processing circuitry 840 is configured to generate the trust decision model based on the captured CSI matrices, wherein the trust decision model is used to determine whether a location where an access request is sent is a trust location.

In some examples, the processing circuitry 840 is configured to generate the trust decision model based on a machine learning method. In some other examples, the processing circuitry 840 is configured to generate the trust decision model based on a statistical method. In some ye other examples, the processing circuitry 840 is configured to generate the trust decision model based on both a machine learning method and a statistical method. In some examples associated with the machine learning method, a machine learning model is training based on ground truth pairs of CSI matrices and trusted or untrusted locations to generate the trust decision model.

In some examples, the apparatus 800 is configured to implement a method associated with method 400 of generating a trust decision model 430 based on a machine learning method. A plurality of CSI matrices 410 are captured by interface circuitry 820 and used by the processing circuitry 840 as input to train a machine learning module to generate the trust decision model 430.

In some examples, the processing circuitry 840 is configured to implement a method 500 of generating a trust decision model based on a machine learning method. The interface circuitry 820 is configured to capture 510 CSI matrices based on one or more locations of one or more user devices, wherein the one or more locations are labeled as trusted or untrusted by one or more trusted users. In some examples, the capture by the interface circuitry 820 refers to capture performed by an access point, such as a Wi-Fi router or a 3GPP base station. In other words, the apparatus 800 is a Wi-Fi router or a 3GPP in these examples. In some other examples, the capture refers to receiving, by the interface circuitry 820, the CSI matrices captured by one or more access points. In these examples, the apparatus 800 is a controller coupled with the one or more access points via wired or wireless connections. In some examples, the CSI matrices captured at 510 are the CSI matrices 410 associated with FIG. 4.

In some examples, the processing circuitry 840 is configured to generate the trust decision model by training a machine learning model based on ground truth pairs of the captured CSI matrices and trust states associated with the CSI matrices. A ground truth pair may comprise a CSI matrix and a trust state associated with the CSI matrix, where the trust state could be trusted or untrusted, and the trust state associated with the CSI matrix represents whether the CSI matrix is associated with a trusted location or an untrusted location. For example, a CSI matrix 410 in FIG. 4 is a ground truth pair because it both comprises a 3×3 CSI matrix and comprises a trust state 420. Based on the ground truth pairs, the trust decision model, such as model 430 in FIG. 4, would be generated.

In some examples, after the trust decision model is generated, the trust decision model could perform access control for a user device based on the captured CSI matrix associated with the user device. The access control is based on whether the trust decision model predicts that the user device is at a trust location or an untrusted location. The CSI matrix associated with the user device refers to a CSI matrix based on the location of a user device. In some examples, the processing circuitry 840 is configured to classify the location of the user device as a trusted location when the user of the user device successfully logged into the wireless network at the location associated with the captured CSI matrix. Based on the classification, a new ground truth pair comprising the captured CSI matrix and the trust state, which indicates a trust location, is generated, so that the new ground truth pair is used by the processing circuitry 840 as input to incrementally train the machine learning model, so that the trust decision model will be consequently improved.

In some examples, the processing circuitry 840 is configured to ask a trusted user to label the location of the user device as trusted or untrusted location, or to verify a prediction made by the machine learning model. In some examples, the trusted user could be a user who is predicted by the trust decision model as being at a trusted location, and/or be a user who gets trusted based on one or more traditional security measures. Based on the action of labeling by the trusted user, a trust state associated with the location is generated by the processing circuitry 840. Consequently, the CSI matrices of this location, where is identified as trusted or untrusted, may be used by the processing circuitry 840 to further training on the machine learning model, which will further improve the trust decision model. In another example where the trusted user is asked to verify a prediction made by the machine learning model, the verification made by the trusted user will be used by the processing circuitry 840 to train the machine learning model. If the verification is that the prediction is correct, the machine learning model may be trained by the processing circuitry 840 to make the same prediction for same or similar further situations; if the verification is that the prediction is wrong, the machine learning model may be trained by the processing circuitry 840 to make a converse prediction for same or similar further situations. Based on operation 540, the accuracy of the trust decision model will be further improved. As operation 530 and operation 540 are not mutually exclusive to each other in many scenarios, the trust decision model may be improved by operation 530 and/or operation 540.

In some examples, the interfaces 820 may include one or more wireless interfaces including antennas, such as MIMO antennas, and/or wired interfaces, such as USB serial interfaces and/or RJ45 interfaces. The wireless interfaces with MIMO antennas may be used as a receiver to capture a CSI matrix based on the location of a user device. The wired interfaces may be used as a receiver to capture the CSI matrix by receiving the CSI matrix from another device. The wireless interfaces are configured to transmit and/or receive Wi-Fi signals, 3GPP signals and/or other wireless signals.

In some examples, the one or more processors 860 may be General Purpose CPUs, Mobile Processors, Server and Data Center Processors, Embedded Processors, Graphics Processing Units (GPUs), Specialized Processors, Microcontrollers, Field-Programmable Gate Arrays (FPGAs), Digital Signal Processors (DSPs), application-specific integrated circuits (ASICs), integrated circuits (ICs) and/or other circuitries having the capability of performing the operations of the controller in each and every example of this disclosure.

In some examples, the phrase “computer-readable non-transitory storage media” may be directed to include all machine and/or computer readable media, with the sole exception being a transitory propagating signal.

In some examples, the storage media 850 may include one or more types of computer-readable storage media capable of storing data, including volatile memory, non-volatile memory, removable or non-removable memory, erasable or non-erasable memory, writeable or re-writeable memory, and the like. For example, storage media 850 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some examples, the logic or computer program 870 may include instructions, data, and/or code, which, if executed by a machine, such as implemented by one or more processors in an apparatus, may cause the machine to perform a method, process, and/or operations as described herein, such as the examples, operations and/or functionalities comprises the examples, operations and/or functional of the access point associated with FIGS. 1, 2, 3, 4, 5, and/or 6, and/or the examples, operations and/or functional of the controller associated with FIGS. 1, 2, 3, 4, 5, and/or 6. The machine may include, for example, any suitable processing platform, computing platform, computing device, processing device, computing system, processing system, computer, processor, or the like, and may be implemented using any suitable combination of hardware, software, firmware, and the like.

In some examples, each of components 820, 840, 850, 860 and 870 in the apparatus 800 is implemented by a corresponding means capable of implementing the functions of the above components. In some examples, storage media 850 is not included in the apparatus 800 because processors 860 may read logic or computer program 870 from a storage media out of the apparatus 800.

In some examples, the logic or computer program 870 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner, or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

In some examples, interfaces 820, storage media 850 and processors 860 communicate with each other via bus and in some other examples, some such entities have direct communicative connections with each other.

The present disclosure relates to a method and system for location-based access control in wireless networks. A core idea is to utilize the CSI matrix, which reflects the characteristics of the wireless communication channel between a user device and an access point, to determine the device's location. This information is used to assess whether the user device is in a “trusted” or “untrusted” location. The system may employ a machine learning model or statistical comparisons to match the captured CSI matrix with known matrices from trusted locations. If a match is found, the system grants access; otherwise, access is denied or restricted. This approach aims to enhance security by providing a more accurate and convenient alternative to traditional methods like password-based authentication, leveraging the unique properties of wireless signals associated with the device's specific location. The proposed concept can be applied in various scenarios, including secure access to sensitive data, where it may complement or replace other security measures.

In the following, some examples of a proposed concept are presented.

An example (e.g., example 1) relates to a method (200) for location-based access control in a wireless network, the method comprising capturing (210) a Channel State Information, CSI, matrix based on a location of a user device. The method comprises determining (220) whether the captured CSI matrix matches a trusted location. The method further comprises performing (230) access control based on whether the captured CSI matrix matches a trusted location.

An example (e.g., example 2) relates to a previously described example (e.g., example 1) or to any of the examples described herein, wherein determining whether the captured CSI matrix matches the trusted location comprises inputting the captured CSI matrix or features thereof into a machine learning model trained to predict a likelihood that the captured CSI matrix corresponds to one of trusted locations.

An example (e.g., example 3) relates to a previously described example (e.g., example 2) or to any of the examples described herein, where the machine learning model comprises an artificial neural network or a support vector machine, SVM, trained to determine whether a CSI matrix corresponds to a trusted location.

An example (e.g., example 4) relates to a previously described example (e.g., example 2 or 3) or to any of the examples described herein, the method further comprises training the machine learning model based on ground truth pairs of CSI matrices and trusted or untrusted locations.

An example (e.g., example 5) relates to a previously described example (e.g., example 4) or to any of the examples described herein, where training the machine learning model comprises classifying the location of the user device as a trusted location if the user successfully logged into the wireless network at the location associated with the captured CSI matrix.

An example (e.g., example 6) relates to a previously described example (e.g., example 4 or 5) or to any of the examples described herein, where training the machine learning model comprises asking a trusted user to label the location of the user device as a trusted or untrusted location, or to verify a prediction made by the machine learning model, and using feedback of the trusted user to incrementally train the machine learning model.

An example (e.g., example 7) relates to a previously described example (e.g., example 1) or to any of the examples described herein, where determining whether the captured CSI matrix matches the trusted location comprises determining one or more statistical properties of the captured CSI matrix. The method further comprises comparing the one or more statistical properties with corresponding statistical properties of CSI matrices corresponding to multiple trusted locations using a similarity measure.

An example (e.g., example 8) relates to a previously described example (e.g., example 7) or to any of the examples described herein, where the statistical properties include at least one of mean, variance, and covariance.

An example (e.g., example 9) relates to a previously described example (e.g., example 7 or 8) or to any of the examples described herein, where the similarity measure includes one of Euclidean distance, Mahalanobis distance, or a correlation coefficient.

An example (e.g., example 10) relates to a previously described example (e.g., one of examples 2 to 9) or to any of the examples described herein, where performing access control comprises granting access to the wireless network if the captured CSI matrix matches a trusted location. The performing access control further comprises denying access if the captured CSI matrix does not match a trusted location.

An example (e.g., example 11) relates to a previously described example (e.g., one of examples 2 to 10) or to any of the examples described herein, where the CSI matrix is associated with Wi-Fi signals, and/or 3rd Generation Partnership Project, 3GPP, wireless signals.

An example (e.g., example 12) relates to a previously described example (e.g., one of examples 2 to 10) or to any of the examples described herein, where the capturing (210) CSI matrices comprises capturing the CSI matrices by a firmware of an access point, or receiving, by a controller, the CSI matrices from an access point.

An example (e.g., example 13) relates to a method (300) of generating a trust decision model. The method comprises capturing (310) CSI matrices associated with one or more user devices at one or more locations. The method further comprises generating (320) the trust decision model based on the captured CSI matrices, wherein the trust decision model is used to determine whether a location where an access request is sent is a trust location.

An example (e.g., example 14) relates to a previously described example (e.g., example 13) or to any of the examples described herein, where generating the trust decision model comprises training a machine learning model based on ground truth pairs of CSI matrices and trusted or untrusted locations (410).

An example (e.g., example 15) relates to a previously described example (e.g., example 14) or to any of the examples described herein, where training the machine learning model comprises classifying the location of the user device as a trusted location if the user successfully logged into the wireless network at the location associated with the captured CSI matrix.

An example (e.g., example 16) relates to a previously described example (e.g., example 14 or 15) or to any of the examples described herein, where training the machine learning model comprises asking a user to label the location of the user device as trusted or untrusted location, or to verify a prediction made by the machine learning model. The training on the machine learning model further comprises using the user feedback to incrementally train the machine learning model.

An example (e.g., example 17) relates to a previously described example (e.g., example 13) or to any of the examples described herein, where generating the trust decision model comprises storing one or more statistical properties of respective CSI matrices corresponding to trusted locations.

An example (e.g., example 18) relates to a previously described example (e.g., one of examples 13 to 17) or to any of the examples described herein, where the trust decision model is based on an artificial neural network or a support vector machine, SVM.

An example (e.g., example 19) relates to a previously described example (e.g., one of examples 13 to 18) or to any of the examples described herein, where the capturing (310) CSI matrices comprises capturing the CSI matrices by a firmware of an access point, or receiving, by a controller, the CSI matrices from an access point.

An example (e.g. example 20) relates to an apparatus (700) comprising an interface (720) and a processing circuitry (740). The apparatus (700) comprises machine-readable instructions (770). The processing circuitry (740) is configured with a trusted execution environment to execute the machine-readable instructions (770) inside the trusted execution environment to perform the method according to one of the examples 1 to 12.

An example (e.g. example 21) relates to an apparatus (800) comprising an interface (820) and a processing circuitry (840). The apparatus (800) comprises machine-readable instructions (870). The processing circuitry (840) is configured with a trusted execution environment to execute the machine-readable instructions (870) inside the trusted execution environment to perform the method according to one of the examples 13 to 19.

An example (e.g. example 22) relates to an apparatus (700) for access control based on locations of user devices. The apparatus comprises an interface (720) and a processing circuitry (740). The interface (720) is configured to capture a Channel State Information, CSI, matrix based on a location of a user device. The processing circuitry (740) is configured to determine whether the captured CSI matrix matches a trusted location. The processing circuitry (740) is further configured to perform access control based on whether the captured CSI matrix matches a trusted location.

An example (e.g. example 23) relates to an apparatus (800) for generating a trust decision model. The apparatus comprises an interface (820) and a processing circuitry (840). The interface (820) is configured to capture CSI matrices associated with one or more user devices at one or more locations. The processing circuitry (840) is configured to generate the trust decision model based on the captured CSI matrices, wherein the trust decision model is used to determine whether a location where an access request is sent is a trust location.

An example (e.g., example 24) relates to a system comprising the apparatus (700) according to example 20 or 22.

An example (e.g., example 25) relates to a system comprising the apparatus (800) according to example 21 or 23.

An example (e.g. example 26) relates to an apparatus (700) for access control based on locations of user devices. The apparatus comprises an interface means (720) and a processing means (740). The interface means (720) is for capturing a Channel State Information, CSI, matrix based on a location of a user device. The processing means (740) is for determining whether the captured CSI matrix matches a trusted location. The processing means (740) is further for performing access control based on whether the captured CSI matrix matches a trusted location.

An example (e.g. example 27) relates to an apparatus (800) for access control based on locations of user devices. The apparatus comprises an interface means (820) and a processing means (840). The interface means (820) is for capturing CSI matrices associated with one or more user devices at one or more locations. The processing means (840) is for generating the trust decision model based on the captured CSI matrices, wherein the trust decision model is used to determine whether a location where an access request is sent is a trust location.

An example (e.g., example 28) relates to a system comprising the apparatus (700) according to example 26 or according to any other example.

An example (e.g., example 29) relates to a system comprising the apparatus (800) according to example 27 or according to any other example.

An example (e.g., example 30) relates to a computer system comprising one of the apparatus (700) of example 20 (or according to any other example), the apparatus (700) of example 22 (or according to any other example), or the device (700) of example 26 (or according to any other example).

An example (e.g., example 31) relates to a computer system comprising one of the apparatus (800) of example 21 (or according to any other example), the apparatus (800) of example 23 (or according to any other example), or the device (800) of example 27 (or according to any other example).

An example (e.g., example 32) relates to a computer system configured to perform the method of one of the examples 1 to 12 (or according to any other example).

An example (e.g., example 33) relates to a computer system configured to perform the method of one of the examples 13 to 19 (or according to any other example).

An example (e.g., example 34) relates to a non-transitory machine-readable storage medium including program code, when executed, to cause a machine to perform the method of one of the examples 1 to 12 (or according to any other example), or the method of one of the examples 13 to 19 (or according to any other example).

An example (e.g., example 35) relates to a computer program having a program code for performing the method of one of the examples 1 to 12 (or according to any other example), or the method of one of the examples 13 to 19 (or according to any other example) when the computer program is executed on a computer, a processor, or a programmable hardware component.

An example (e.g., example 36) relates to a machine-readable storage including machine-readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components.

Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A method for location-based access control in a wireless network, the method comprising
capturing a Channel State Information, CSI, matrix based on a location of a user device;
determining whether the captured CSI matrix matches a trusted location; and
performing access control based on whether the captured CSI matrix matches a trusted location.

2. The method of claim 1, wherein determining whether the captured CSI matrix matches the trusted location comprises:
inputting the captured CSI matrix or features thereof into a machine learning model trained to predict a likelihood that the captured CSI matrix corresponds to one of trusted locations.

3. The method of claim 2, wherein the machine learning model comprises an artificial neural network or a support vector machine, SVM, trained to determine whether a CSI matrix corresponds to a trusted location.

4. The method of claim 2, further comprising:
training the machine learning model based on ground truth pairs of CSI matrices and trusted or untrusted locations.

5. The method of claim 4, wherein training the machine learning model comprises:
classifying the location of the user device as a trusted location if the user successfully logged into the wireless network at the location associated with the captured CSI matrix.

6. The method of claim 4, wherein training the machine learning model comprises:
asking a trusted user to label the location of the user device as a trusted or untrusted location, or to verify a prediction made by the machine learning model, and
using feedback of the trusted user to incrementally train the machine learning model.

7. The method of claim 1, wherein determining whether the captured CSI matrix matches the trusted location comprises:
determining one or more statistical properties of the captured CSI matrix; and
comparing the one or more statistical properties with corresponding statistical properties of CSI matrices corresponding to multiple trusted locations using a similarity measure.

8. The method of claim 7, wherein the statistical properties include at least one of mean, variance, and covariance.

9. The method of claim 7, wherein the similarity measure includes one of Euclidean distance, Mahalanobis distance, or a correlation coefficient.

10. The method of claim 1, wherein performing access control comprises:
granting access to the wireless network if the captured CSI matrix matches a trusted location; and
denying access if the captured CSI matrix does not match a trusted location.

11. The method of claim 1, wherein the CSI matrix is associated with Wi-Fi signals, and/or 3rd Generation Partnership Project, 3GPP, wireless signals.

12. The method of claim 1, wherein the capturing (210) CSI matrices comprises capturing the CSI matrices by a firmware of an access point, or receiving, by a controller, the CSI matrices from an access point.

13. A method of generating a trust decision model, the method comprising
Capturing CSI matrices associated with one or more user devices at one or more locations; and
generating the trust decision model based on the captured CSI matrices, wherein the trust decision model is used to determine whether a location where an access request is sent is a trust location.

14. The method of claim 13, wherein generating the trust decision model comprises
training a machine learning model based on ground truth pairs of CSI matrices and trusted or untrusted locations.

15. The method of claim 14, wherein training the machine learning model comprises
classifying the location of the user device as a trusted location if the user successfully logged into the wireless network at the location associated with the captured CSI matrix.

16. The method of claim 14, wherein training the machine learning model comprises:
asking a user to label the location of the user device as trusted or untrusted location, or to verify a prediction made by the machine learning model, and
using the user feedback to incrementally train the machine learning model.

17. The method of claim 13, wherein generating the trust decision model comprises
storing one or more statistical properties of respective CSI matrices corresponding to trusted locations.

18. The method of claim 13, wherein the trust decision model is based on an artificial neural network or a support vector machine, SVM.

19. The method of claim 13, wherein the capturing (310) CSI matrices comprises capturing the CSI matrices by a firmware of an access point, or receiving, by a controller, the CSI matrices from an access point.

20. A non-transitory machine-readable storage medium including program code, when executed, to cause a machine to perform a method for location-based access control in a wireless network, comprising capturing a CSI matrix based on a location of a user device;
determining whether the captured CSI matrix matches a trusted location; and
performing access control based on whether the captured CSI matrix matches a trusted location.
